(19) United States
(12) Patent Application Publication
(10) Pub. No.: US 2006/0043933 A1
(43) Pub. Date: Mar. 2, 2006

(54) Battery voltage monitor

(76) Inventor: Gary R. Latinis, Pottsboro, TX (US)

Correspondence Address: JOHN E. VANDIGRIFF, 190 N. STEMMONS FRWY., SUITE 200, LEWISVILLE, TX, 75067, US

(21) Appl. No.: 10/929,462

(22) Filed: Aug. 31, 2004

(51) Int. Cl. H02J 7/00

(52) U.S. Cl. 320/132

(57) ABSTRACT

A voltage monitor that is operable in two distinct modes. The first mode is the basic model without a transmitter or receiver. The only functions are battery voltage and audible alarm. The second mode is the Voltminder with a alarm and data transmission capability. The standard Voltminder placed in the second mode by adding a transmitter board to the vehicle located Voltminder and a receiver to the home located Voltminder. A programmable monitor reads and tracks a battery voltage, and indicates when a battery voltage drops below a predetermined value. A display shows battery status, and an audible signal is produced when the battery falls below a predetermined voltage.

### FIELD OF THE INVENTION

The invention relates to a voltage monitor, and specifically to a device for monitoring a battery from a location near the battery by a direct connection, or by monitoring a battery from a remote location using transmitting and receiving devices.

### BACKGROUND OF THE INVENTION

A review of the prior art disclose patents related to battery monitor. The background of the invention is shown in the following patents. These patents are distinct from the invention and are described to show the prior art and the distinctness of the invention from this prior art.

U.S. Pat. No. 6,242,157 A system and method for monitoring and reporting on the condition of a vehicle battery which measures battery voltage and current drain during engine start, and computes the battery dynamic internal resistance (IR) and dynamic polarization resistance (PR) from these quantities. Also, the quiescent voltage (QV) of the battery, which is that measured while the vehicle electrical system has a current drain of from 0 to a predetermined amount, is measured and the battery state-of-charge (SoC) is computed from the QV. From these quantities, calculations are made of quantities such as rate of change of dynamic IR and PR to analyze battery condition, rate of change of QV and SoC to predict the time during which the battery can still start the engine, and minimum ambient temperature at which the battery will be able to start the engine, and of other conditions. Appropriate messages can be displayed of the measured and computed quantities as well as warnings to advise the driver of various real and potential problems related to the battery, its cables and components of its charging system.

U.S. Pat. No. 5,900,724 A low battery voltage detection and warning system connected to sense a voltage charge of a power source within a vehicle such as the vehicle battery. The low battery voltage detection and warning system includes a voltage sensor connected to the power source for sensing a voltage value of the power source and a processing device connected to the voltage sensor for comparing the sensed voltage value to a reference value and determining if the sensed voltage value is less than the reference value. An alarm is connected to the processing device for generating an alarm upon a determination by the processing device that the sensed voltage value is less than the reference value. The alarm may produce at least one of an audible and visual alarm to alert the operator of the vehicle that the battery voltage is low and should be checked. The determination that the battery voltage is low indicates that the vehicle will only start a few more times before the battery is charged to a value too small to start the vehicle.

U.S. Pat. No. 4,320,334 Apparatus for providing a continuous indication of battery state-of-charge under load in a system in which the battery is subject to varying load conditions. The apparatus stores a value representative of battery open circuit terminal voltage and reduces the stored value while the battery is loaded at a rate proportional to the difference between the stored value and a scaled value of actual battery terminal voltage. If the scaled value exceeds the stored value, the stored value is increased to a value corresponding to the scaled value.

U.S. Pat. No. 6,373,256 A low battery detect circuit with digitally programmable detect levels. The programmable low battery detect circuit includes a comparator that compares a stable reference voltage against a battery-supplied voltage as divided down by a digitally programmable resistive divider chain. By programably varying the resistance of the divider chain, the low battery detect threshold level can be varied depending on the requirements of the application.

### SUMMARY OF THE INVENTION

The invention, also know as “Voltminder” performs the following functions as described below. The invention connects to one or more batteries requiring monitoring via a cigarette lighter cord, by direct connection, or by a wireless transmitter which transmits to a receiver monitoring device. The battery may be mounted in a motor vehicle, boat, recreation vehicle, or any place requiring the monitoring of battery voltage.

A battery is connected to voltage monitor which has a user set alarm system. When the voltage of the battery stays below a user set value for one minute, the device will activate a warning light and buzzer. If the device is in a quite mode, it will display a “Low battery” message on a display screen. A similar warning will be issued if the rate of voltage change passes a set, predetermined value. The device is designed for situations where the battery powers a starter for a internal combustion motor, or where an alternator charges the battery from a running engine, for example, a boat or truck. The constant value detection warns of a battery unable to start a motor on the next start up attempt due to lack of charge, or large internal resistance. If the voltage of a battery drops quickly while the engine is running, it is likely there is a problem with the alternator, and the device warns of such a situation in a manner according to the current mode. A temperature sensor in the engine compartment may be included to adjust the steady voltage limit in accordance with the temperature to which the battery is exposed.

The VoltMinder performs two very critical functions: Alerts the operator that the battery is approaching a voltage that will not be sufficient for the engine to start; and Alerts the operator that the battery is not charging while the engine is in operation.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 is a block diagram of the battery voltage monitor;

FIG. 2 is a circuit diagram of the battery voltage monitor;

FIG. 3 is a circuit diagram of a receiver device used in conjunction with the battery voltage monitor;

FIG. 4 is a circuit diagram of a transmitter device used in conjunction with the battery voltage monitor; and

FIG. 5 shows an example of a voltminder.

### DESCRIPTION OF A PREFERRED EMBODIMENT

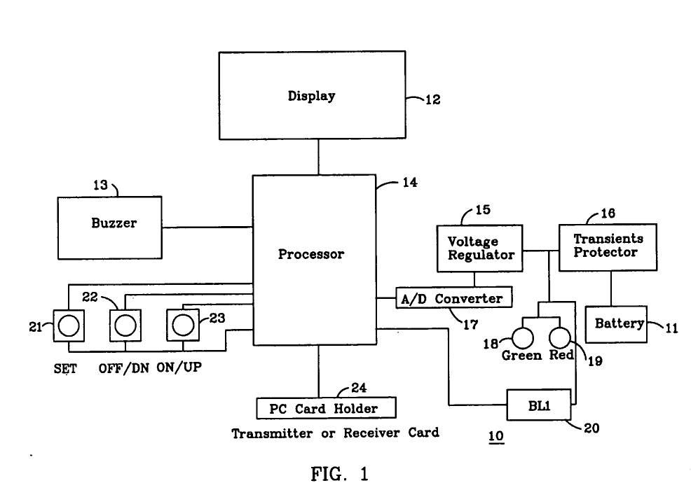

FIG. 1 is a block diagram of the battery voltage monitor 10. It consist basically of a processor 14 that controls and allows programming of the voltage monitor. A front mounted LCD display 12 displays the real time battery voltage and battery alarm set point during setup mode. Display 12 will also display LOW BATT when the battery voltage drops below the set point. Display 12 also shows the battery ID followed by the battery voltage for that battery in a multi-battery system. On a front panel of the voltage monitor are Red LED (19)and Green (18) LEDs, and three push button switches, 21, 22 and 23. The Green LED 18 displays the status of the Alarm sounder (Green LED illuminated for sounder enabled). When Green LED 18 is illuminated, and the battery voltage drops below the user defined and stored set point for one minute, Piezo sounder 13 will beep on and off at a fast rate. Red LED 19 serves two functions during setup mode. It indicates that the monitor is in setup mode, and secondly the LED 19 will flash when the battery voltage drops below the set point for one minute.

The three switches; UP 23, DOWN 22, and MODE (SET) 21 operate as follows. Pressing the MODE switch 21 once will cause the unit to enter Setup mode. Setup mode is indicated by the Red LED 19 being illuminated. During Setup mode, the LCD 12 will display the Set point voltage (if the battery voltage drops below this value, the alarm will sound). This set point is stored in non-volatile Flash memory (in Processor 14). During Setup mode, each closure of the UP 23 and DOWN 22 buttons will raise or lower the set point by one count. When the set point exceeds 13.00 it will roll over to 10.50 and if the set point goes below 10.5 it will roll over to 13.00. The Setup mode is exited by pressing the MODE 21 button again, the Red LED 19 will extinguish and the LCD display 12 will display the real-time battery voltage.

While in normal monitoring Mode, the UP button 23 will enable the sounder if pressed once, the Green LED 18 will illuminate. Pressing the UP button 23 again will extinguish the Green LED 18 and disable the sounder 13. In both modes, the LOW BATT symbol will illuminate on display 12 if the battery voltage drops below the set point.

If the UP button 23 is pressed while the alarm has been activated (battery voltage below set point) the beeping alarm is cancelled and only the LOW BATT is displayed. If the battery voltage rises above the set point value at any time, the alarm will turn off and the voltage will again have to drop below the set point for one minute.

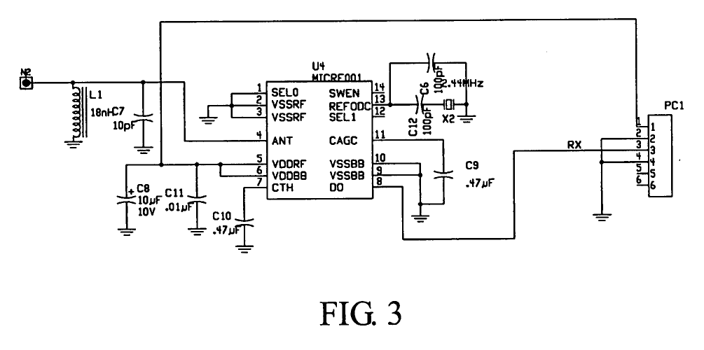

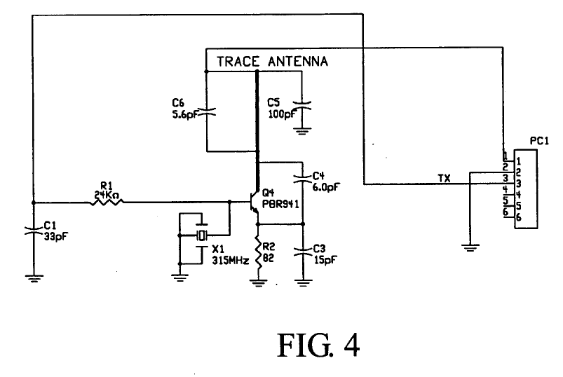

As shown in FIG. 1, the voltage monitor connects to battery 11 though a transient protector 16 and a voltage regulator 15. The voltage is then converted to a digital value with the A/D converter 17. A back light device 20 is used as a back light for display 12. A PC card holder 24 is used for attaching a transmitter or receiver device as described below with reference to FIGS. 3 and 4.

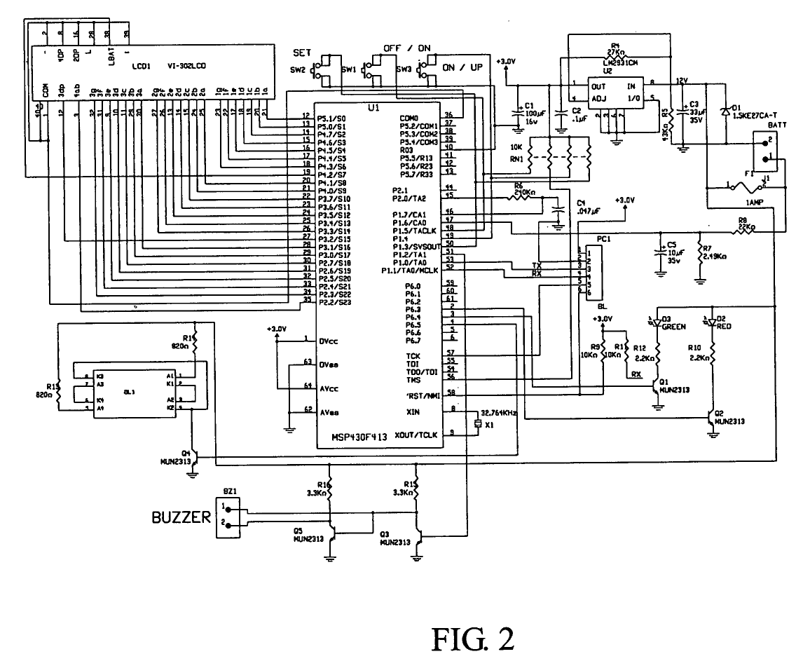

FIG. 2 is a circuit diagram showing an example of a circuit that may be used for the voltage monitor. The battery (BATT) being monitored connects to a 3.0 volt voltage regulator U2 that provides a regulated reference voltage for the invention. The battery voltage is also divided by a factor of 1/10 to scale the voltage to the maximum tolerated by the microprocessor, 3 volts. The invention is protected from positive transients above 27 volts and negative transients above 1 volt by D1. A Delta-sigma A/D converter made up of R6 and C4 and an internal analog comparator, converts the scaled battery voltage to binary value internal to the microprocessor U1. The LCD (LCD1) displays this binary value as a voltage. This binary value is compared against a Flash memory stored user changeable set point to determine is the alarm is activated. The microprocessor U1 generates a 2.6 KHz square wave to drive the Piezo sounder (BZ1) ON and OFF alert the user of a low battery condition.

LED's D2 and D3 and switches SW1, SW2, and SW3 are interfaced to the microprocessor in a standard manner. The microprocessor U1 chosen has an internal analog comparator for the Delta-sigma A/D converter and circuitry to generating proper voltage levels and drive for a static LCD display.

The actual voltage of the battery is displayed via the digital readout on VoltMinder. A warning sound will be activated when the battery voltage is reduced to a level that is designated by the operator. This warning voltage level can be set from 10.5 to 13.5 volts DC.

A detailed Description of Components of the voltage monitor are as follows.

R1—3.3K ohm. Load for Buzzer Driver Q5, half of push-pull buzzer driver.

R2—3.3K ohm. Load for Buzzer Driver Q3, half of push pull buzzer driver.

R3—-820 ohm. Current limiting resistor for LCDI and Back light BLI. This resistor supplies current to the right side of the backlight. 4 green LED's.

R4—27K ohm. Feedback resistor for voltage regulator U2. This resistor along with R5 form a voltage divider set for 1.2 volts at pin 4 of U2. This results in a regulated voltage of 3.0 volts at Pin 1 of U2.

R5—43K ohm. Part of voltage divider along with R4. Sets Pin 4 voltage of U2 at 1.2 volts when the output is 3.0 volts.

R6—240K ohm. Forms the RC network for the Delta-sigma A/D converter along with C4. This resistor is powered by the Output port of UI which controls the charge on capacitor C4.

R7—2.49K ohm. Part of the input voltage divider along with R8. These resistors scale the input voltage by 1/10 th giving a voltage of 1 volt at the comparitor input CAO on UI for a input voltage of 10 volts.

R8—22K ohm. Part of the input voltage divider along with R7. These resistors scale the input voltage by 1/10th, giving a voltage of 1.0 volt at the comparitor input CAO on UI for input voltage of 10 volts.

R9—lOK ohm. Pull-up resistor for UI reset pin. Keeps the reset pin normally at 3 volts.

R10—2.2K ohm. Current limiting resistor for LED D2 the RED LED. Sets the LED current for 4.6 mamps with a 12 volt power input.

R11—lOK ohm. Pull-up resistor for UI P1.1 Pin 52 and PCI Pin 4. Keeps the pin normally at 3 volts when a Transmitter or no expansion board is installed at PCI. When the receiver board is added this pin is pulled to ground by the Receiver board signaling the microcontroller Ui to act as a Voltminder Receiver.

R12—2.2K ohm. Current limiting resistor for LED D3 the GREEN LED. Sets the LED current for 4.4 mamps with a 12 volt power input.

R13—820 ohm. Current limiting resitor for LCDI Backlight BLI. This resistor supplies current to the left side of the backligh, 4 green LED's.

RN13—IOK ohm. Resistor Network. Provides pull-ups to 3 volts for three input switches SW 1-3. Holds the Port pins 1.3 to 1.5 at logic high, 3 volts when a switch is not pressed. RN 1-b provides pull-up for the TMS signal.

BL1—LED Backlight. Green LED backlight mounted behind the LCD1 Liquid crystal display. The backlight constists of a pair of 4 series connected Green LED's. These LED's provide a uniform backlighting for the LCD display. This backlight is controlled by transistor Q4 which can turn the backlight ON or OFF.

D1—27 volt Transient Suppressor. Absorbs the energy of transients on the power line that exceed 27 volts or a negative 0.7 volts. Protects all circuits from High voltage and negative transients.

D2—RED SMT LED. Red Light Emitting Diode that indicates the unit is in setup mode or the Alarm has been activated. Driven by transistor Q2 that amplifies the signal from P6.3 on UI.

D3—GREEN SMT LED. Green Light Emitting Diode that indicates the alarm is On or Off. Driven by transistor QI that amplifies the signal from P6.4 on U1.

C1—100 uF. Output smoothing and stabalizing capacitor for regulator U2.

C2—.1 uF. High speed transient filter for regulator U2.

C3—33 uF. Input Filter and transient holdup capacitor.

C4—.O47 uF. Charge storage for Delta-sigma ND converter.

C5—1OuF. Input voltage averaging filter. Removes high frequency noise from the scaled battery voltage to provide a stable display.

X1—32.768 KHz Crystal. Main timing source for the microcontroller U1.

F1—Resetable. Provides over current protection if a component failure causes a Polymer Fuse increase in current draw. F1 becomes a high resistance if the current rating is exceeded. Resets when power is disconnected.

SW1—OFF/Down Switch Pushbutton switch. When pressed takes P1.5 to ground.

SW2—SET Switch Pushbutton switch. When pressed takes P1.3 to ground.

SW3—ON/UP Switch Pushbutton switch. When pressed tages P1.4 to ground.

BZ1—Piezo Buzzer 3.5 KHz piezoelectric transducer. Driven by Q5,Q3 which are driven by Ui timer A. Timer A generates a 3.5 Khz square wave when the program commands the buzzer to activate.

Q1—MUN2313 NPN transistor with integrated bias resistors. Provides drive current for LED D3, while isolating Ui from the battery input.

Q2—MUN2313 NPN transistor with integrated bias resistors. Provides drive current for LED D2, while isolating Ui from the battery input.

Q3—MUN2313 transistor. Driver for the Piezoelectric Buzzer. When the timer output TA1 goes high the collector of Q3 goes low taking the buzzer line to ground while feeding the base of Q5, taking its' collector high. When TA1 goes low, Q3 collector low, Q5 collector high, giving a 24 volt p-p signal across the piezo buzzer.

Q4—MUN23I3 NPN transistor with integrated bias resistors. When the base goes high the collector goes low, turning on the LCD Jacklight.

Q5—MUN2314. Same as Q3.

LCD1—Liquid Crystal 3.5 digit static LCD display. 19.99 max display. Backlite Display.

PCI—6 Pin Connector Programming/Expansion connector. Programs U1's Flash memory using TI programming algorithim. Receiver or transmitter board connected at this point. A transmitter board has pin 4 open, signalling the micro that a transmitter board is connected. When Pin 4 is grounded on the receiver board the micro assumes a receiver is connected. Pin 1 is 3 volts, Pin 2 is ground, Pin 3 is data in or out, Pin4 is config. Pin 5 is TCLK for programming. Pin 5 is Reset.

U1—MSP43OF4I 3 16 bit microcontroller with LCD drivers.

U2—LM293ICM Low Dropout linear regulator with automotive transient survival ratings. Resistors R4 and R5 set the output for 3.00 volts.

J1—Power Jack Power input from battery system being measured.

Two Mode Operation

The Voltminder can operate in two distinct modes. The first mode is the basic model without a transmitter or receiver. The only functions are battery voltage and audible alarm. The second mode is the Voltminder with a alarm and data transmission capability. The standard Voltminder placed in the second mode by adding a transmitter board to the vehicle located Voltminder and a receiver to the home located Voltminder.

A receiver (FIG. 3) and transmitter (FIG. 4) that plug into the Voltminder programming port PC1 enable the following features.

Remote warning of low battery condition. The Voltminder with transmitter will transmit the voltage and alarm status to a remote Voltminder with receiver which will beep and flash the LED's if the voltage is below the receiver's set point or the transmitters alarm is activated. The user can select the receiver alarm trigger source, either receiver set point or transmitted alarm condition.

The transmitted signal can warn an owner of a vehicle if the battery of the vehicle has dropped to the point where it will not start the car when the owner needs it. The receiver can be placed in the bedroom or near the user. Multiple receivers can monitor the transmitter.

The Voltminder with receiver can display the alarm status and test for set points for many transmitters. The set points and trigger conditions can be set for each transmitter. The Display will show the Transmitter ID followed by the voltage followed by the Trigger condition denoted by an “5” for receiver set point or an “A” for transmitter alarm condition.

The transmitter will transmit its data at a random interval ranging from 1 minute to 90 seconds; this will minimize interference with other transmitters and comply with FCC rules. The receiver will display all signals being received and display the ID and voltage. The user can select display all or select a single transmitter for display.

Remote warning of low battery condition. The Voltminder with transmitter will transmit the voltage and alarm status to a remote Voltminder with receiver which will beep and flash the LED's if the voltage is below the receiver's setpoint or the transmitters alarm is activated. The user can select the receiver alarm trigger source, either receiver setpoint or transmitted alarm condition.

Receiver

The receiver design is a standard generic low Power UHF receiver. If a transmitter board, as shown in FIG. 4, is plugged into the programming port PC1 on the Voltminder, the invention becomes capable of sending the battery voltage and alarm status via RF to the remote receiver of FIG. 3. The Voltminder will transmit a serial number identifying the transmitter to the receiver via Bi-phase data encoding of 433 MHz RF on-off keying. The serial number, voltage and alarm status are transmitted.

A detailed Description of Components of the receiver are as follows.

C1 Capacitor 10 pF. Selected to resonate at 315 MHz with Inductor L1. Parallel tank circuit for input tuning.

C2 Capacitor 10 uF. Power supply bypass capacitor for low frequencies.

C3 Capacitor .01 uF. Power supply bypass capacitor for high frequencies.

C4 Capacitor .47 uF. Data slicer time constant timing capacitor.

C5 Capacitor 10 pF. Series loading capacitor for X2, value selected according to crystal manufacturer specifications.

C6 Capacitor 10 pF. Parallel loading capacitor for X2, value selected according to crystal manufacturer specifications.

C7 Capacitor .47uF. AGC time constant timing capacitor.

L1 Inductor 18 nH. Selected to resonate at 315 MHz with Capacitor C7. Parallel tank circuit for input tuning.

X1 Crystal 2.44 MHz. Frequency reference for receiver local oscillator. 315 MHz/129.

U1 Receiver IC MICRF001 Superhet receiver for 315 MHz.

Transmitter The transmitter shown in FIG. 4 is a UHF transmitter using FSK, 00 K, AM or FM modulation. Data is output on Pin 3 of PC1. The receiver design is a standard generic low Power UHF receiver. If the receiver board as shown in FIG. 3 is connected to the programming port of a Voltminder the invention becomes a remote receiver. When the receiver is plugged into the programming connector PCI, pin 4 is grounded. In all cases, when power is applied to the Voltminder, the microprocessor checks the state of this pin, if high the Voltminder works as a transmitter, if low as a receiver. The 433 MHz receiver detects the Bi-phase data and presents it to the microprocessor for decoding. Serial number, voltage and alarm status are received.

A detailed Description of Components of the transmitter are as follows.

C1 Capacitor 33 pF. High frequency low pass filter blocks RF from entering the main Voltminder circuit.

C3 Capacitor 15 pF. Selected to resonate at 315 MHz with trace antenna/inductor and the series combination of C4 and C3 in parallel with C6. Sets ratio of ˜3:1 with C4 for oscillation of Q4.

C4 Capacitor 6.0 pF. Selected to resonate at 315 MHz with trace antenna/inductor and the series combination of C4 and C3 in parallel with C6.

C5 Capacitor 100 pF. Power supply bypass capacitor for high frequencies.

C6 Capacitor 5.6 pF. Resonates with Trace antenna at 315 MHz. R1 Resistor 24 K ohm. Sets DC bias and power level for Q4.

R2 Resistor 82 ohm. Sets DC operating point and power output for Q4.

L1 Trace Antenna. Designed to resonate at 315 MHz with Capacitor C3 C4 and C6.

X1 SAW Resonator 315 MHz. Frequency reference for transmitter.

Q1 PBR941 RF Transistor. High frequency RF transistor. Provides gain at 315 MHz.

Calibration

Power is switched off to the Voltminder. The mode and Up buttons are pressed and held down. A precise 12 volts is applied to the Voltminder. As the program starts, the status of the mode and UP switches if low places the device in calibration mode. The voltage is assumed to be exactly 12.00 volts. The microprocessor will do an A/D conversion and store the result. Based on this result and the 12.00 volt input, a scaling factor is computed. This scaling factor is stored in Flash and used in the Voltminder A/D conversion process. Power is disconnected and the Voltminder returns to normal operation.

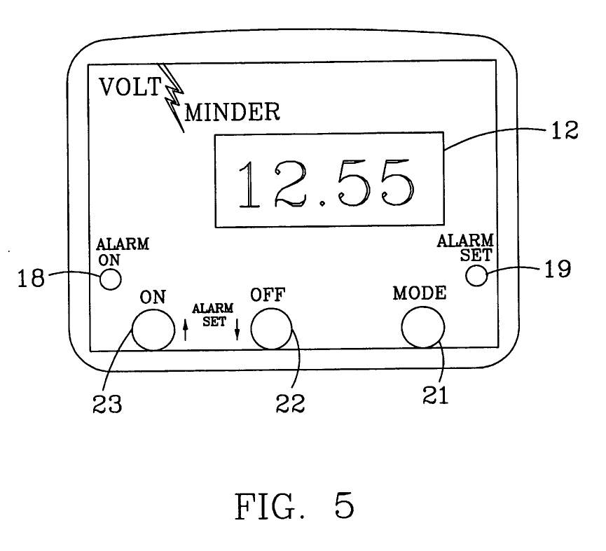

FIG. 5 shows an example of a Voltminder. A front mounted LCD display 12 displays the real time battery voltage and battery alarm set point during setup mode. Display 12 will also display LOW BATT when the battery voltage drops below the set point. Display 12 also shows the battery ID followed by the battery voltage for that battery in a multi-battery system. On a front panel of the voltage monitor are Red LED (19)and Green (18) LEDs, and three push button switches, 21, 22 and 23. The Green LED 18 displays the status of the Alarm sounder (Green LED illuminated for sounder enabled). When Green LED 18 is illuminated, and the battery voltage drops below the user defined and stored set point for one minute, Piezo sounder (not shown) will beep on and off at a fast rate. Red LED 19 serves two functions during setup mode. It indicates that the monitor is in setup mode, and secondly the LED 19 will flash when the battery voltage drops below the set point for one minute.

The three switches; UP 23, DOWN 22, and MODE (SET) 21 operate as follows. Pressing the MODE switch 21 once will cause the unit to enter Setup mode. Setup mode is indicated by the Red LED 19 being illuminated. During Setup mode, the LCD 12 will display the Set point voltage (if the battery voltage drops below this value, the alarm will sound). This set point is stored in non-volatile Flash memory (in Processor 14, FIG. 1). During Setup mode, each closure of the UP 23 and DOWN 22 buttons will raise or lower the set point by one count. When the set point exceeds 13.00 it will roll over to 10.50 and if the set point goes below 10.5 it will roll over to 13.00. The Setup mode is exited by pressing the MODE 21 button again, the Red LED 19 will extinguish and the LCD display 12 will display the real-time battery voltage.

While in normal monitoring Mode, the UP button 23 will enable the sounder if pressed once, the Green LED 18 will illuminate. Pressing the UP button 23 again will extinguish the Green LED 18 and disable the sounder 13. In both modes, the LOW BATT symbol will illuminate on display 12 if the battery voltage drops below the set point.

If the UP button 23 is pressed while the alarm has been activated (battery voltage below set point) the beeping alarm is cancelled and only the LOW BATT is displayed. If the battery voltage rises above the set point value at any time, the alarm will turn off and the voltage will again have to drop below the set point for one minute.

As an example, the VoltMinder may be approximately 4″×2″×0.75″ (a little smaller than a pack of cigarettes) and comes with a 6-ft cord that plugs into a vehicle's power outlet (cigarette lighter).

What is claimed:

1. A voltage monitor for monitoring a battery and indicating when the battery voltage discharges below a predetermined value, comprising:
a programmable monitor for reading and tracking a battery voltage, and indicating when a battery voltage drops below a predetermined value;
a transient protector connected between a battery and the programmable monitor;
a display for displaying battery status; and
an audible signal generator for producing a sound when a monitored battery falls below a predetermined voltage.

2. The voltage monitor according to claim 1, including a card holder for connecting one of a transmitter and received to the voltage monitor.

3. The voltage monitor according to claim 1, including a voltage regulator connected to the programmable monitor.

4. The voltage monitor according to claim 1, including a transmitter to transmit a signal when the monitored voltage falls below a predetermined value.

5. The voltage monitor according to claim 1, including a receiver to receive a signal from a voltage monitor, with a transmitter, when the monitored voltage falls below a predetermined value.

6. The voltage monitor according to claim 1, including a plurality of switches for programing the voltage monitor.

7. A voltage monitor for monitoring a battery and indicating when the battery voltage discharges below a predetermined value, comprising:
a programmable monitor for reading and tracking a battery voltage, and indicating when a battery voltage drops below a predetermined value;
a transient protector connected between a battery and the programmable monitor;
a display for displaying battery status;
an audible signal generator for producing a sound when a monitored battery falls below a predetermined voltage; and
a card holder for connecting one of a transmitter and received to the voltage monitor.

8. The voltage monitor according to claim 7, including a voltage regulator connected to the programmable monitor.

9. The voltage monitor according to claim 7, including a transmitter to transmit a signal when the monitored voltage falls below a predetermined value.

10. The voltage monitor according to claim 7, including a receiver to receive a signal from a voltage monitor, with a transmitter, when the monitored voltage falls below a predetermined value.

11. The voltage monitor according to claim 7, including a plurality of switches for programing the voltage monitor.

12. The voltage monitor according to claim 7, including a flash memory in which the value of the predetermine voltage is stored.

13. A voltage monitor for monitor a battery and indicating when the battery voltage discharges below a predetermined value, comprising:
a programmable monitor for reading and tracking a battery voltage, and indicating when a battery voltage drops below a predetermined value;
a transient protector connected between a battery and the programmable monitor;
a display for displaying battery status;
an audible signal generator for producing a sound when a monitored battery falls below a predetermined voltage; and
one of a receiver to receive a signal from a voltage monitor, and a transmitter to transmit a signal when the monitored voltage falls below a predetermined value.
